(19) United States
(12) Patent Application Publication
(10) Pub. No.: US 2023/0373815 A1
(43) Pub. Date: Nov. 23, 2023

(54) COBALT-FREE NICKEL-MANGANESE CATHODE MATERIAL AND PREPARATION AND APPLICATION THEREOF

(71) Applicants: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP EV RECYCLING CO., LTD., Changsha (CN)

(72) Inventors: Dong Huang, Foshan (CN); Changdong Li, Foshan (CN); Qian Wang, Foshan (CN); Jingjing Liu, Foshan (CN); Dingshan Ruan, Foshan (CN)

(21) Appl. No.: 18/230,727

(22) Filed: Aug. 7, 2023

Related U.S. Application Data
(63) Continuation of application No. PCT/CN2021/142817, filed on Dec. 30, 2021.

(30) Foreign Application Priority Data
Mar. 29, 2021 (CN) 202110335607.5

(51) Int. Cl. C01G 53/00; H01M 10/0525

(52) U.S. Cl. CPC C01G 53/50; H01M 10/0525; C01P 2006/40; C01P 2004/03; C01P 2002/74; C01P 2006/12; C01P 2004/61; C01P 2004/51

(57) ABSTRACT

The invention relates to the technical field of battery materials and discloses a cobalt-free layered nickel-manganese cathode material and a preparation method and application thereof. The chemical formula of the cobalt-free layered nickel-manganese cathode material is LiₐNiₓMn_{y}Me_{z}O₂@M_{b}, and Me is at least one selected from the group consisting of Zr, Al, W, Sr, Ti and Mg; M is at least one selected from the group consisting of Al₂O₃, CeO₂, TiO₂, Yb₂O₃, Nb₂O₅, La₂O₃, WO₃, titanium sol, aluminum sol, titanium-aluminum sol, aluminum isopropoxide, butyl titanate, aluminum dihydrogen phosphate or lithium tungstate. The present invention achieves a shallow coating through high temperature calcination followed by metal oxide coating, which is beneficial to prevent the material from microcracks expansion caused by the material structure and internal stress change during the charging-discharging cycles.

### CROSS-REFERENCE TO RELATED APPLICATIONS

The present application is a continuation application of PCT application No. PCT/CN2021/142817 filed on Dec. 30, 2021, which claims the benefit of Chinese Patent Application No. 202110335607.5 filed on Mar. 29, 2021. The contents of all of the aforementioned applications are incorporated by reference herein in their entirety.

### TECHNICAL FIELD

The invention relates to the technical field of battery materials, and specifically relates to a cobalt-free nickel-manganese cathode electrode material and a preparation method and application thereof.

### BACKGROUND

At present, the cathode materials with higher energy density on the market are nickel-cobalt-manganese ternary cathode materials. However, because the nickel-cobalt-manganese ternary cathode materials contain cobalt. Cobalt is a scarce resource and the price of cobalt is showing an increasing trend, which makes the price of the cathode materials related to the content of cobalt fluctuates greatly. Therefore, the development of cobalt-free cathode materials has become a trend in the future, addressing the problem of high cost of cathode materials due to the price of cobalt. Besides, there are few reports available for layered nickel-manganese cathode materials, especially the cobalt-free cathode materials with low or medium nickel content.

Therefore, there is an urgent need to develop a layered cobalt-free cathode material with a relatively low nickel content.

### SUMMARY OF THE INVENTION

The present invention aims to solve at least one of the technical problems existing in the above-mentioned prior art. For this reason, the present invention proposes a cobalt-free nickel-manganese cathode material and its preparation method and application. The nickel content of the cathode material produced is relatively low, and the valence states of some elements in the cathode material are changed by doping high-valence metal elements. It can stabilize the crystal structure of the ternary cathode material, allow lithium ions to intercalate or deintercalate, reduce the energy barrier, make more electron vacancies available in the cathode material, and increase the capacity of the cathode material.

In order to achieve the aforementioned objective, the following technical solution is adopted in the invention.

A cobalt-free layered nickel-manganese cathode material, having the chemical formula of LiₐNiₓMn_{y}Me_{z}O₂@M_{b}, and Me is at least one of selected from the group consisting of Zr, Al, W, Sr, Ti and Mg; M is at least one selected from the group consisting of Al₂O₃, CeO₂, TiO₂, Yb₂O₃, Nb₂O₅, La₂O₃, WO₃, titanium sol, aluminum sol, titanium aluminum sol, aluminum isopropoxide, butyl titanate, aluminum dihydrogen phosphate and lithium tungstate, wherein 0.9≤a≤1.10, 0.50≤x≤0.70, 0.50≤y≤0.30, 0.001≤z≤0.009, 0.001≤b≤0.005.

Preferably, the cobalt-free layered nickel-manganese cathode material has a specific surface area of 0.4-0.9 m²/g, and a particle size D50 of 3.0-5.0 μm.

A preparation method for the cobalt-free layered nickel-manganese cathode material comprises the following steps:
(1) Preparing a solution A with a nickel salt and a manganese salt, and then adding a mixture of sodium hydroxide and ammonia dropwise, stirring to perform a reaction, washing a resulting product, and drying to obtain a nickel-manganese hydroxide precursor NiₓMn_{y}(OH)₂;
(2) Mixing the nickel-manganese hydroxide precursor NiₓMn_{y}(OH)₂ with a lithium source and a dopant, performing a first calcination and pulverizing to obtain a cobalt-free nickel-manganese cathode material LiₐNiₓMn_{y}Me_{z}O₂;
(3) Mixing the cobalt-free nickel-manganese cathode material LiₐNiₓMn_{y}Me_{z}O₂ with a coating agent A, and performing a second calcination and sieving to obtain a metal oxide-coated cobalt-free layered nickel-manganese cathode material;
(4) Spray coating agent B on the surface of the metal oxide-coated cobalt-free layered nickel-manganese cathode electrode material for wet coating and vacuum drying to obtain a double-coated cobalt-free layered cathode electrode material LiₐNiₓMn_{y}Me_{z}O₂@M_{b}.

Preferably, in step (1), the nickel salt is at least one selected from the group consisting of NiSO₄, Ni(CH₃COO)₂, Ni (NO₃)₂, C₂O₄·Ni and NiCl₂.

Preferably, in step (1), the manganese salt is at least one selected from the group consisting of MnSO₄, Mn(NO₃)₂, MnC₂O₄ and MnCl₂.

Preferably, in step (1), the solution A is prepared to have a nickel and manganese ions concentration of 2.0 mol/L-3.2 mol/L.

Preferably, in step (1), the reaction is carried out at a temperature of 55±5° C. for 2-10 h.

Preferably, in step (2), the lithium source is at least one selected from the group consisting of LiOH·H₂O, Li₂CO₃ and CH₃COOLi.

Preferably, in step (2), the dopant is at least one selected from the group consisting of ZrO₂, Al₂O₃, Al (OH)₃, WO₃, SrO, TiO₂, Mg (OH)₂ and gO₂.

Preferably, in step (2), the precursor and the lithium salt are in a metal molar content ratio Li/M1=0.9-1.10 (M1 is the metal molar content of Ni, Co, and Mn in the precursor).

Preferably, in step (2), the first calcination is carried out at a temperature of 450° C.-980° C. for 5 h-27 h.

Preferably, in step (3), the coating agent A is at least one selected from the group consisting of Al₂O₃, CeO₂, TiO₂, Yb₂O₃, Nb₂O₅, La₂O₃ and WO₃.

Preferably, in step (3), the second calcination is carried out at a temperature of 250° C.-600° C. for 5 h-12 h.

Preferably, in step (4), the coating agent B is at least one selected from the group consisting of titanium sol, aluminum sol, titanium aluminum sol, aluminum isopropoxide, butyl titanate, aluminum dihydrogen phosphate and lithium tungstate.

Preferably, in step (4), the double-coated cobalt-free layered nickel-manganese cathode electrode material is a cobalt-free layered nickel-manganese cathode electrode material coated with a surface film and a metal oxide.

Preferably, in step (4), the vacuum drying is carried out at a temperature of 130° C.-180° C.

A battery includes the cobalt-free nickel-manganese cathode material.

Compared with the prior art, the beneficial effects of the present invention are as follows:
1. In the present invention, a shallow coating is achieved through high temperature calcination followed by the metal oxide coating. The shallow coating is beneficial to prevent a microcrack expansion caused by the material structure and internal stress change during charging and discharging cycles. The shallow coating on the surface of the material can effectively prevent micro-cracks from expanding to the surface of the material, increase the service life of the material under high voltage, and improve the cycle performance of the material. The capacity retention rate of the material after 100 cycles reaches 96.5%.
2. The present invention adopts the method of coating the coating agent on the surface of the material by wet spraying to form a dense film-like coating that is different from the point contact coating obtained by dry coating, which is more conducive to preventing the material from being directly in contact with the electrolyte, which inhibits the dissolution of cations in the material, improves the material structural stability, and improves the cycle performance of the material.
3. In the present invention, inexpensive Mn is used to replace expensive Co or part of nickel to reduce the preparation cost by 20-30%. The nickel content of the material is managed to be relatively low, and low-cost manganese stabilizes the material structure. Also, high-valence metal elements are doped to change the valence state of some elements in the material which can stabilize the crystal structure of the material and reduce the energy barrier of the intercalation/deintercalation of lithium ions, so that there are more electron vacancies in the material leading to a increased material capacity. As in Example 1, the first charge capacity of the cathode electrode material reaches 208.6 mAh/g, the first discharge capacity reaches 186.9 mAh/g, and the first discharge efficiency is as high as 89.6%.

### BRIEF DESCRIPTION OF DRAWINGS

FIG. 1 is an SEM image of a cobalt-free layered nickel-manganese cathode material having a single crystal morphology obtained in step (3) of Example 1;

FIG. 2 is an SEM image of a cobalt-free layered nickel-manganese cathode electrode material coated with a metal oxide in step (5) of Example 1 having a single crystal morphology;

FIG. 3 is an SEM image of the double-coated cobalt-free layered nickel-manganese cathode material obtained in step (6) of Example 1;

FIG. 4 is an SEM image of a cobalt-free layered nickel-manganese cathode material obtained in step (3) of Example 2 having a single crystal morphology;

FIG. 5 is an SEM image of a cobalt-free layered nickel-manganese cathode material coated with a metal oxide obtained in step (5) of Example 2 having a single-crystal-like morphology;

FIG. 6 is a schematic diagram of the coating on the cobalt-free layered nickel-manganese cathode material coated with the coating agent in Example 1-2;

FIG. 7 shows the XRD comparison chart of the titanium sol film-coated and metal oxide-coated cobalt-free layered nickel-manganese cathode material having a single crystal morphology obtained in Example 1-2 and the cobalt-free layered cathode materials obtained in Comparative Example 1-3.

### DETAILED DESCRIPTION OF ILLUSTRATED EXAMPLES

Hereinafter, the concept of the present invention and the technical effects produced by it will be described clearly and completely with reference to the embodiments, so as to fully understand the purpose, features and effects of the present invention. Obviously, the described embodiments are only a part of the embodiments of the present invention, rather than all of them. Based on the embodiments of the present invention, other embodiments obtained by those skilled in the art without creative work belong to the scope of protection of the present invention.

### EXAMPLE 1

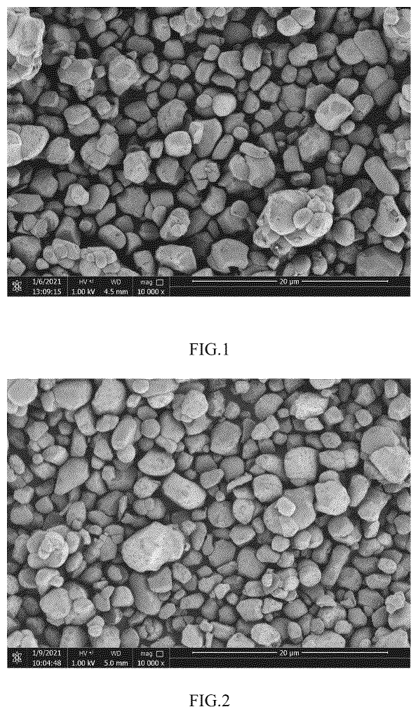

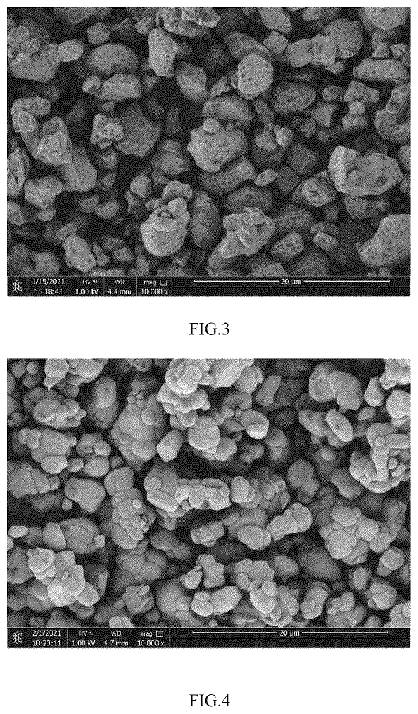

The preparation method of the cobalt-free layered nickel-manganese cathode material (Li_{1.06}Ni_{0.6}Mn_{0.3974}Me_{0.0026}O₂@(Al₂O₃)_{0.001}·(TiO₂)_{0.0015}) of this embodiment comprising the specific steps as follows:
(1) Preparing 2.5 mol/L solution A with NiSO₄ and MnSO₄ in a molar ratio of Ni:Mn=6:4, stirring the solution in a stirred tank reactor at 25 rpm/min, then adding dropwise sodium hydroxide and ammonia at a flow rate of 5 m³/h to perform a reaction at a temperature of 55° C.-60° C. for 2 h. After the reaction is completed, washing a resulting product with deionized water and placed in a centrifuge for filtration at a centrifugal speed of 600 rpm/min for 90 min, then drying at 150° C. for 4 h, and finally to obtain the cobalt-free nickel manganese hydroxide precursor Ni_{0.6}Mn_{0.4}(OH)₂;
(2) Mixing the above-mentioned cobalt-free nickel-manganese hydroxide precursor Ni_{0.6}Mn_{0.4}(OH)₂ with lithium carbonate, WO₃ and SrO (the molar ratio of lithium to the Ni, Co, and Mn metals in the hydroxide precursor is 1.06:1, the W element is doped in a content of 2000 ppm, and the Sr element is doped in a content of 1500 ppm) with a high-speed mixer at a mixing speed of 300 rpm/min for 10 min and then at 500 rpm/min for 30 min to obtain a mixture;
(3) Performing a first calcination to the mixture in a box furnace at a loading capacity of 3.5 kg/loading in an air atmosphere. The air inlet pressure is 0.15 Mpa, and the air is introduced using a bottom air inlet method at a flow rate of 10 m³/h. The calcination is carried out as follows: first heating the mixture at a heating rate of 3° C./min to raise the temperature to 550° C., then at a 2.5° C./min heating rate to a temperature of 750° C. and holding the temperature for 5 h, and then heating at a heating rate of 2° C./min to a temperature of 950° C. and holding the temperature for 11 h, and finally lowering the temperature to room temperature at a cooling rate of 3° C./min, and then performing jet pulverization to obtain a material having particle size D50 of 3.5 μm, which is the cobalt-free layered nickel-manganese cathode material with a single crystal morphology as shown in FIG. 1;
(4) Then mixing the above-mentioned cobalt-free layered nickel-manganese cathode electrode material with Al₂O₃ (content of Al is 1000 ppm), in a high-speed mixer at a mixing speed of 200 rpm/min for 10 min, then at 250 rpm/min for 15 min, and then at 300 rpm/min for 20 min, to obtain a mixture;
(5) Subjecting the mixture to a second calcination in a box furnace. The calcination process is as follows: f first heating the mixture at a heating rate of 3° C./min to raise the temperature to 600° C., then holding the temperature for 6 h, then lowering the temperature to room temperature at a cooling rate of 3° C./min, and then screening with a sieve of 300 mesh to obtain a Al₂O₃ coated cobalt-free layered nickel-manganese cathode material with a single crystal morphology as shown in FIG. 2;
(6) Diluting a titanium sol (where Ti is 1500 ppm) in an alcohol phase by 3 times and spraying the resulting dilution on the metal oxide-coated cobalt-free layered nickel-manganese cathode material to perform a wet coating, followed by performing vacuum drying at a drying temperature of 150° C. for 4 h to obtain the double-coated cobalt-free layered nickel manganese cathode material Li_{1.06}Ni_{0.6}Mn_{0.3974}Me_{0.0026}O₂@(Al₂O₃)_{0.001}·(TiO₂)_{0.0015} as shown in the FIG. 3.

Experimental Test
(1) Preparation of a positive electrode piece: the self-made cathode material in step (6) of the above example 1 is used as an active material, NMP is used as a solvent, coating a mixture of the active material, SP and Poly tetra fluoroethylene in a mass ratio of 90:4:6 evenly on an aluminum foil, and prepare the positive electrode piece by rolling and so on.
(2) Battery assembly: The battery is assembled in a dry stainless steel glove box filled with argon with lithium metal as a negative electrode and 1 mol/L LiPF6 as an electrolyte.

Test: After the assembled battery is allowed to stand for 12 h, the electrochemical performance of the battery is tested using a battery test system at 25° C. and a current of 0.1 C to a charging voltage of (2.75˜4.4) V.

### Example 2

The preparation method of the cobalt-free layered nickel-manganese cathode material (Li_{1.04}Ni_{0.6}Mn_{0.3969}Me_{0.0031}O₂@(Al₂O₃·TiO₂)_{0.001}·(Li₂WO₄)_{0.0015}) of this embodiment comprising the specific steps as follows:
(1) Preparing 2.3 mol/L solution A with NiSO₄ and MnSO₄ in a molar ratio of Ni:Mn=6:4, stirring the solution in a stirred tank reactor at 30 rpm/min, then adding dropwise sodium hydroxide and ammonia at a flow rate of 6.3 m³/h to perform a reaction at a temperature of 55° C.-60° C. for 2.5 h. After the reaction is completed, washing a resulting product with deionized water and placing it in a centrifuge for filtration at a centrifugal speed of 600 rpm/min for 90 min, then drying at 150° C. for 4 h, and finally to obtain the cobalt-free nickel manganese hydroxide precursor Ni_{0.6}Mn_{0.4}(OH)₂;
(2) Mixing the above-mentioned cobalt-free nickel-manganese hydroxide precursor Ni_{0.6}Mn_{0.4}(OH)₂ with lithium carbonate, ZrO₂, WO₃ and SrO (the molar ratio of lithium to the Ni, Co, and Mn metals in the hydroxide precursor is 1.04:1, the Zr element is doped in a content of 1500 ppm, the W element is doped in a content of 1500 ppm, and the Sr element is doped in a content of 800 ppm) with a high-speed mixer at a mixing speed of 300 rpm/min for 10 min, at 400 rpm/min for 15 min and then at 500 rpm/min for 30 min to obtain a mixture;
(3) Performing a first calcination to the mixture in a box furnace at a loading capacity of 3.5 kg/loading in an air atmosphere. The air inlet pressure is 0.15 Mpa, and the air is introduced using a bottom air inlet method at a flow rate of 8 m³/h. The calcination is carried out as follows: first heating the mixture at a heating rate of 3° C./min to raise the temperature to 550° C., then at a 2.5° C./min heating rate to a temperature of 750° C. and holding the temperature for 6 h, and then heating at a heating rate of 2° C./min to a temperature of 945° C. and holding the temperature for 11 h, and finally lowering the temperature to room temperature at a cooling rate of 3° C./min, and then performing jet pulverization to obtain a material having particle size D50 of 4.5 μm, which is the cobalt-free layered nickel-manganese cathode material with a single-crystal-like morphology as shown in FIG. 4;
(4) Then mixing the above-mentioned cobalt-free layered nickel-manganese cathode electrode material with TiO₂, Al₂O₃ (wherein Ti is 1000 ppm, Al is 1000 ppm) in a high-speed mixer at a mixing speed of 200 rpm/min for 10 min, then at 250 rpm/min for 15 min, and then at 300 rpm/min for 20 min, to obtain a mixture;
(5) Subjecting the mixture to a second calcination in a box furnace. The calcination process is as follows: f first heating the mixture at a heating rate of 3° C./min to raise the temperature to 650° C., then holding the temperature for 6 h, then lowering the temperature to room temperature at a cooling rate of 2.5° C./min, and then screening with a sieve of 300 mesh to obtain a Al₂O₃ coated cobalt-free layered nickel-manganese cathode material with a single-crystal-like morphology as shown in FIG. 5;
(6) Diluting a Lithium Tungstate (wherein W is 1500 ppm) in an alcohol phase by 3 times and spraying the resulting dilution on the metal oxide-coated cobalt-free layered nickel-manganese cathode material to perform a wet coating, followed by performing vacuum drying at a drying temperature of 140° C. for 4 h to obtain the double-coated cobalt-free layered nickel manganese cathode material Li_{1.04}Ni_{0.6}Mn_{0.3969}Me_{0.0031}O₂@(Al₂O₃·TiO₂)_{0.001}·(Li₂WO₄)_{0.0015}).

Experimental Test
(1) Preparation of a positive electrode piece: the self-made cathode material in step (5) of the above example 2 is used as an active material, NMP is used as a solvent, coating a mixture of the active material, SP and Poly tetra fluoroethylene in a mass ratio of 90:4:6 evenly on an aluminum foil, and prepare the positive electrode piece by rolling and so on.
(2) Battery assembly: The battery is assembled in a dry stainless steel glove box filled with argon with lithium metal as a negative electrode and 1 mol/L LiPF₆ as an electrolyte.

Test: After the assembled battery is allowed to stand for 12 h, the electrochemical performance of the battery is tested using a battery test system at 25° C. and a current of 0.1 C to a charging voltage of (2.75˜4.4) V.

### Comparative Example 1

The preparation method of the cobalt-free layered nickel-manganese cathode material (Li_{1.06}Ni_{0.6}Mn_{0.3974}Me_{0.0026}O₂) of this embodiment comprising the specific steps as follows:
(1) Preparing 2.5 mol/L solution A with NiSO₄ and MnSO₄ in a molar ratio of Ni:Mn=6:4, stirring the solution in a stirred tank reactor at 25 rpm/min, then adding dropwise sodium hydroxide and ammonia at a flow rate of 5 m³/h to perform a reaction at a temperature of 55° C.-60° C. for 2 h. After the reaction is completed, washing a resulting product with deionized water and placing it in a centrifuge for filtration at a centrifugal speed of 600 rpm/min for 90 min, then drying at 150° C. for 4 h, and finally to obtain the cobalt-free nickel manganese hydroxide precursor Ni_{0.6}Mn_{0.4}(OH)₂;
(2) Mixing the above-mentioned cobalt-free nickel-manganese hydroxide precursor Ni_{0.6}Mn_{0.4}(OH)₂ with lithium carbonate, WO₃ and SrO (the molar ratio of lithium to the Ni, Co, and Mn metals in the hydroxide precursor is 1.06:1, the W element is doped in a content of 2000 ppm, and the Sr element is doped in a content of 1500 ppm) with a high-speed mixer at a mixing speed of 300 rpm/min for 10 min, and then at 500 rpm/min for 30 min to obtain a mixture;
(3) Performing a first calcination to the mixture in a box furnace at a loading capacity of 3.5 kg/loading in an air atmosphere. The air inlet pressure is 0.15 Mpa, and the air is introduced using a bottom air inlet method at a flow rate of 10 m³/h. The calcination is carried out as follows: first heating the mixture at a heating rate of 3° C./min to raise the temperature to 550° C., then at a 2.5° C./min heating rate to a temperature of 750° C. and holding the temperature for 5 h, and then heating at a heating rate of 2° C./min to a temperature of 950° C. and holding the temperature for 11 h, and finally lowering the temperature to room temperature at a cooling rate of 3° C./min, and then performing jet pulverization to obtain a material having particle size D50 of 3.5 μm, which is the cobalt-free layered nickel-manganese cathode material with a single crystal morphology as shown in FIG. 1;
(4) Subjecting the cobalt-free layered nickel-manganese cathode material having particle size D50 of 3.5 μm to a second calcination in a box furnace. The calcination process is as follows: first heating the material at a heating rate of 3° C./min to raise the temperature to 600° C., then holding the temperature for 6 h, then lowering the temperature to room temperature at a cooling rate of 3° C./min, and then screening with a sieve of 300 mesh to obtain a cobalt-free layered nickel-manganese cathode material with a single crystal morphology Li_{1.06}Ni_{0.6}Mn_{0.3974}Me_{0.0026}O₂;

The test method for the material prepared in Comparative Example 1 is the same as the test steps (1), (2), and (3) in Example 1.

### Comparative Example 2

The preparation method of the cobalt-free layered nickel-manganese cathode material of this comparative example has the following specific steps:

The preparation method of Comparative Example 2 is the same as the cathode material obtained in steps (1) (2) (3) (4) (5) in Example 1. The test method of the prepared material is the same as the test steps (1) (2) (3) in Example 1. Same.

### Comparative Example 3

The preparation method of the cobalt-free layered nickel-manganese cathode material of this embodiment comprising the specific steps as follows:
(1) Preparing 2.3 mol/L solution A with NiSO₄ and MnSO₄ in a molar ratio of Ni:Mn=6:4, stirring the solution in a stirred tank reactor at 30 rpm/min, then adding dropwise sodium hydroxide and ammonia at a flow rate of 6.3 m³/h to perform a reaction at a temperature of 55° C.-60° C. for 2 h. After the reaction is completed, washing a resulting product with deionized water and placing it in a centrifuge for filtration at a centrifugal speed of 600 rpm/min for 90 min, then drying at 150° C. for 4 h, and finally to obtain the cobalt-free nickel manganese hydroxide precursor Ni_{0.6}Mn_{0.4}(OH)₂;
(2) Mixing the above-mentioned cobalt-free nickel-manganese hydroxide precursor Ni_{0.6}Mn_{0.4}(OH)₂ with lithium carbonate, ZrO₂, WO₃ and SrO (the molar ratio of lithium to the Ni, Co, and Mn metals in the hydroxide precursor is 1.04:1, the Zr element is doped in a content of 1500 ppm the W element is doped in a content of 1500 ppm, and the Sr element is doped in a content of 800 ppm) with a high-speed mixer at a mixing speed of 300 rpm/min for 10 min, and 400 rpm/min for 15 min then at 500 rpm/min for 30 min to obtain a mixture;
(3) Performing a first calcination to the mixture in a box furnace at a loading capacity of 3.5 kg/loading in an air atmosphere. The air inlet pressure is 0.15 Mpa, and the air is introduced using a bottom air inlet method at a flow rate of 10 m³/h. The calcination is carried out as follows: first heating the mixture at a heating rate of 3° C./min to raise the temperature to 550° C., then at a 2.5° C./min heating rate to a temperature of 750° C. and holding the temperature for 5 h, and then heating at a heating rate of 2° C./min to a temperature of 950° C. and holding the temperature for 11 h, and finally lowering the temperature to room temperature at a cooling rate of 3° C./min, and then performing jet pulverization to obtain a material having particle size D50 of 3.5 μm, which is the cobalt-free layered nickel-manganese cathode material with a single crystal morphology as shown in FIG. 1;
(4) Subjecting the cobalt-free layered nickel-manganese cathode material having particle size D50 of 3.5 μm to a second calcination in a box furnace. The calcination process is as follows: first heating the material at a heating rate of 3° C./min to raise the temperature to 600° C., then holding the temperature for 6 h, then lowering the temperature to room temperature at a cooling rate of 3° C./min, and then screening with a sieve of 300 mesh to obtain a cobalt-free layered nickel-manganese cathode material with a single crystal morphology Li_{1.04}Ni_{0.6}Mn_{0.3969}Me_{0.0031}O₂;

Experimental Test
(1) Preparation of positive electrode piece: The self-made positive electrode material in step (4) of the above comparative example 3 is used as the active material, NMP is used as the solvent, and the mass ratio of the active material:SP:PTFE 90:4:6 is mixed Coat evenly on the aluminum foil, and prepare the positive electrode piece by rolling etc.;
(2) Battery assembly: The battery is assembled in a stainless-steel dry glove box filled with argon with lithium metal as the negative electrode and 1 mol/L LiPF6 as the electrolyte.

Test: After the assembled battery is allowed to stand for 12 hours, the electrochemical performance of the battery is tested using a battery test system at 25° C. and a current of 0.1 C to a charging voltage (2.75˜4.4) V.

The comparison results of the electrochemical performance of the cathode materials of Example 1-2 and Comparative Example 1-3 are shown in Table 1:

TABLE 1
Comparison results of the electrochemical performance of the
cathode materials of Example 1-2 and Comparative Example 1-3

| | | | | Discharging capacity |
|---|---|---|---|---|
| | | | | retention rate after |
| | | First charge | | 100 cycles (%) |
| | | efficiency | | (Capacity retention |
| | | (%) = first | | rate = discharging |
| | First discharging | discharging | Specific capacity | capacity at 100^{th} |
| | specific capacity | capacity/first | after 50 cycles | cycle/discharging |
| | (mAh/g) | charging | (mAh/g) | capacity at first |
| / | (25° C., 0.1 C) | capacity | (25° C., 0.1 C) | cycle) |
| Example 1 | 186.9 | 89.6 | 184.3 | 96.5 |
| Example 2 | 186.6 | 89.3 | 183.6 | 95.9 |
| Comparative | 177.4 | 86.7 | 172.3 | 94.3 |
| Example 1 | | | | |
| Comparative | 182.7 | 88.1 | 177.8 | 95.4 |
| Example 2 | | | | |
| Comparative | 178.5 | 86.8 | 173.0 | 94.6 |
| Example 3 | | | | |

Table 1 is the comparison of the electrochemical performance of the cathode materials of Example 1-2 and Comparative Example 1-3. The first discharging specific capacity of Example 1 is 186.9 mAh/g at 0.1 C with the highest voltage of 4.4V, and the discharging efficiency is 89.6%; The discharging specific capacity after 50 cycles is 184.3 mAh/g, the capacity retention rate at the 50th cycle is 98.6%, and the capacity retention rate at the 100th cycle is 96.5%, which is significantly better than the electrochemical performance of the cathode material of the Comparative Examples. The doping of the metals can stabilize the crystal structure of the ternary material, reduce the energy barrier for lithium ion intercalation and deintercalation. And the method of evenly coating the cathode material with the metal oxide followed by surface coating with a titanium sol film reduces contact between the electrolyte and the cathode material, leading to reduced side reactions. Therefore, the single crystal cathode material doped with the metal oxide and having a film-like coating formed by spraying improves the capacity and cycle performance of the battery. Secondly, the materials in Comparative example 1 exhibits a single crystal morphology and the materials in Comparative Example 3 has a single-crystal-like morphology, the single-crystal-like material is superior to the single crystal material in terms of capacity, first charging efficiency, the electrical performance at the 50th cycle and the capacity retention rate at the 100th cycle. By comparing Example 2 with Comparative Example 3, or by comparing Comparative Example 1 with Comparative Example 2, the former material in both group exhibits higher first discharging capacity, first charging efficiency, as well as the specific capacity after 50 cycles and the capacity retention rate at 100th cycle, indicating that the electrical properties if the cathode material coated with metal oxide can be effectively improved, as well as the capacity and cycle performance of a battery with the material.

FIG. 1 is an SEM image of a cobalt-free layered nickel-manganese cathode material with a single crystal morphology obtained in step (3) of Example 1. It can be seen from the figure that while having a single crystal morphology with good single crystal dispersion, the material also has relatively uniform primary particles.

FIG. 2 is an SEM image of a cobalt-free layered nickel-manganese cathode material coated with a metal oxide having a single crystal morphology obtained in step (5) of Example 1. It can be seen from the figure that the surface of the nickel-manganese cathode material is evenly coated with the coating agent.

FIG. 3 is the SEM image of the cobalt-free layered nickel-manganese cathode material coated with the film-like titanium sol and the metal oxide having a single crystal morphology in step (6) of Example 1. It is indicated in the figure, the surface of the material is evenly coated with a film-like coating agent by spraying.

FIG. 4 is an SEM image of the cobalt-free layered nickel-manganese cathode material with a single-crystal-like morphology obtained in step (3) in Example 2. It is indicated in the figure that the material has a single-crystal-like morphology, and its primary particle size is relatively uniform.

FIG. 5 is an SEM image of the cobalt-free layered nickel-manganese cathode material coated with a metal oxide having a single-crystal-like morphology obtained in step (5) of Example 2. As shown in the figure, the surface of the nickel-manganese cathode material is uniformly coated with the Coating agent.

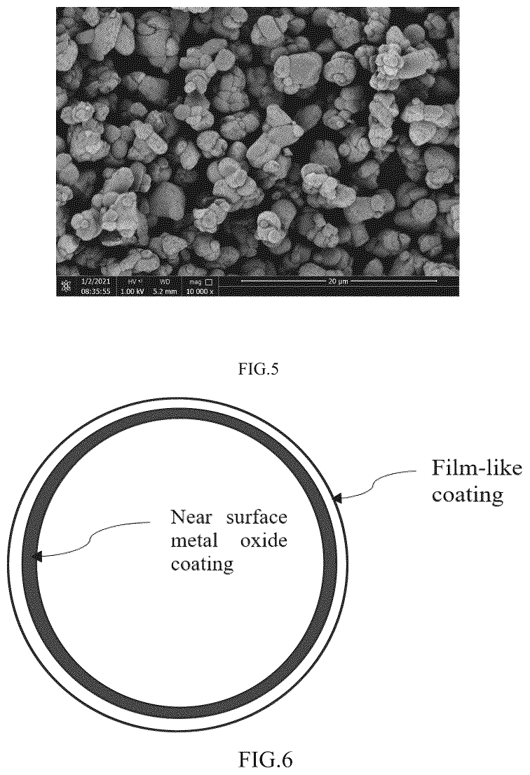

FIG. 6 is a schematic diagram of the coating layers of the cobalt-free layered nickel-manganese cathode material coated with the coating agents in Example 1-2; the double coating of the materials in Example 1 and Example 2 is vividly shown in the figure.

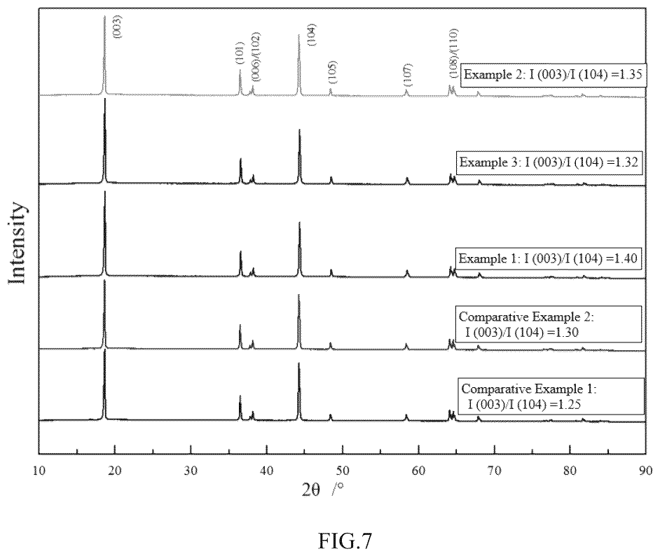

FIG. 7 shows the XRD comparison chart of the materials obtained in Example 1-2 and Comparative Example 1-3. It can be seen that the prepared material has the characteristic peaks of peak (003) and peak (104) belonging to a α-NaFeO₂ type layered structure, and peak (006), peak (102), peak (108) and peak (110) which are commonly used to characterize the order degree of the two-dimensional layered structure, indicating that the prepared material has a layered structure. Secondly, peak (006), peak (102), peak (108) and peak (110) of the material all have good splitting degree, indicating that the material has an ordered layered structure. Furtherly, the figure shows a I(003)/I(104) value greater than 1.2, indicating that the material has a relatively complete layered structure. Among them, the material prepared in Example 1 has the best layered structure, in which I(003)/I(104) reaches 1.40, and peak (006), peak (102), (108) and peak (110) have obviously better splitting degree, indicating that the material prepared by the method of uniformly coating the cathode material with a metal oxide and then coating the surface of the material with a titanium sol film exhibits better layered structure.

The embodiments of the present invention have been described in detail above with reference to the accompanying drawings. However, the present invention is not limited to the above-mentioned embodiments. Within the scope of knowledge possessed by those of ordinary skill in the art, various modifications can be made without departing from the purpose of the present invention. Variety. In addition, in the case of no conflict, the embodiments of the present invention and the features in the embodiments can be combined with each other.

1. A cobalt-free layered nickel-manganese cathode material, having a chemical formula of LiₐNiₓMn_{y}Me_{z}O₂@M_{b}, wherein Me is at least one selected from the group consisting of Zr, Al, W, Sr, Ti and Mg; M is at least one selected from the group consisting of Al₂O₃, CeO₂, TiO₂, Yb₂O₃, Nb₂O₅, La₂O₃, WO₃, titanium sol, aluminum sol, titanium-aluminum sol, aluminum isopropoxide, butyl titanate, aluminum dihydrogen phosphate and lithium tungstate, wherein 0.9≤a≤1.10, 0.50≤x≤0.70, 0.50≤y≤0.30, 0.001≤z≤0.009, 0.001≤b≤0.005.

2. The cobalt-free layered nickel-manganese cathode material according to claim 1, wherein the cobalt-free layered nickel-manganese cathode material has a specific surface area of 0.4-0.9 m²/g, and a particle size D₅₀ of 3.0-5.0 μm.

3. A preparation method of the cobalt-free layered nickel-manganese cathode material according to claim 1, comprising the following steps:
(1) preparing a solution A with a nickel salt and a manganese salt, and then adding a mixture of sodium hydroxide and ammonia dropwise, stirring to perform a reaction, washing a resulting product, and drying to obtain a nickel-manganese hydroxide precursor NiₓMn_{y}(OH)₂;
(2) mixing the nickel-manganese hydroxide precursor NiₓMn_{y}(OH)₂ with a lithium source and a dopant, performing a first calcination and pulverizing to obtain a cobalt-free nickel-manganese cathode material LiₐNiₓMn_{y}Me_{z}O₂;
(3) mixing the cobalt-free nickel-manganese cathode material LiₐNiₓMn_{y}Me_{z}O₂ with a coating agent A, performing a second calcination and sieving to obtain a metal oxide coated cobalt-free layered nickel-manganese cathode material;
(4) spraying a coating agent B on a surface of the metal oxide coated cobalt-free layered nickel-manganese cathode material to perform wet coating and vacuum drying to obtain a double-coated cobalt-free layered cathode electrode material LiₐNiₓMn_{y}Me_{z}O₂@M_{b}.

4. A preparation method of the cobalt-free layered nickel-manganese cathode material according to claim 2, comprising the following steps:
(1) preparing a solution A with a nickel salt and a manganese salt, and then adding a mixture of sodium hydroxide and ammonia dropwise, stirring to perform a reaction, washing a resulting product, and drying to obtain a nickel-manganese hydroxide precursor NiₓMn_{y}(OH)₂;
(2) mixing the nickel-manganese hydroxide precursor NiₓMn_{y}(OH)₂ with a lithium source and a dopant, performing a first calcination and pulverizing to obtain a cobalt-free nickel-manganese cathode material LiₐNiₓMn_{y}Me_{z}O₂;
(3) mixing the cobalt-free nickel-manganese cathode material LiₐNiₓMn_{y}Me_{z}O₂ with a coating agent A, performing a second calcination and sieving to obtain a metal oxide coated cobalt-free layered nickel-manganese cathode material;
(4) spraying a coating agent B on a surface of the metal oxide coated cobalt-free layered nickel-manganese cathode material to perform wet coating and vacuum drying to obtain a double-coated cobalt-free layered cathode electrode material LiₐNiₓMn_{y}Me_{z}O₂@M_{b}.

5. The preparation method according to claim 3, wherein in step (1), the nickel salt is at least one selected from the group consisting of NiSO₄, Ni(CH₃COO)₂, Ni(NO₃)₂, C₂O₄·Ni and NiCl₂;
wherein in step (1), the manganese salt is at least one selected from the group consisting of MnSO₄, Mn (NO₃)₂, MnC₂O₄ and MnCl₂.

6. The preparation method according to claim 4, wherein in step (1), the nickel salt is at least one selected from the group consisting of NiSO₄, Ni(CH₃COO)₂, Ni(NO₃)₂, C₂O₄·Ni and NiCl₂;
wherein in step (1), the manganese salt is at least one selected from the group consisting of MnSO₄, Mn (NO₃)₂, MnC₂O₄ and MnCl₂.

7. The preparation method according to claim 3, wherein in step (2), the lithium source is at least one selected from the group consisting of LiOH·H₂O, Li₂CO₃ and CH₃COOLi.

8. The preparation method according to claim 4, wherein in step (2), the lithium source is at least one selected from the group consisting of LiOH·H₂O, Li₂CO₃ and CH₃COOLi.

9. The preparation method according to claim 3, wherein in step (2), the dopant is at least one selected from the group consisting ZrO₂, Al₂O₃, Al (OH)₃, WO₃, SrO, TiO₂, Mg (OH)₂ and MgO₂.

10. The preparation method according to claim 4, wherein in step (2), the dopant is at least one selected from the group consisting ZrO₂, Al₂O₃, Al (OH)₃, WO₃, SrO, TiO₂, Mg (OH)₂ and MgO₂.

11. The preparation method according to claim 3, wherein in step (2), the first calcination is carried out at 450° C.-980° C. for 5 h-27 h; wherein in step (3), the second calcination is carried out at 250° C.-600° C. for 5 h-12 h.

12. The preparation method according to claim 4, wherein in step (2), the first calcination is carried out at 450° C.-980° C. for 5 h-27 h; wherein in step (3), the second calcination is carried out at 250° C.-600° C. for 5 h-12 h.

13. The preparation method according to claim 3, wherein in step (3), the coating agent A is at least one selected from the group consisting of Al₂O₃, CeO₂, TiO₂, Yb₂O₃, Nb₂O₅, La₂O₃ and WO₃.

14. The preparation method according to claim 4, wherein in step (3), the coating agent A is at least one selected from the group consisting of Al₂O₃, CeO₂, TiO₂, Yb₂O₃, Nb₂O₅, La₂O₃ and WO₃.

15. The preparation method according to claim 3, wherein in step (4), the coating agent B is at least one selected from the group consisting of titanium sol, aluminum sol, titanium-aluminum sol mixture, aluminum isopropoxide, butyl titanate, aluminum dihydrogen phosphate and lithium tungstate.

16. The preparation method according to claim 4, wherein in step (4), the coating agent B is at least one selected from the group consisting of titanium sol, aluminum sol, titanium-aluminum sol mixture, aluminum isopropoxide, butyl titanate, aluminum dihydrogen phosphate and lithium tungstate.

17. A battery comprising the cobalt-free layered nickel-manganese cathode material according to claim 1.

18. A battery comprising the cobalt-free layered nickel-manganese cathode material according to claim 2.
